(19) United States
(12) Patent Application Publication
(10) Pub. No.: US 2007/0223121 A1
(43) Pub. Date: Sep. 27, 2007

(54) Method of making reflector for solar collector or the like and corresponding product

(75) Inventors: Pierre-Yves Franck, Arlon (BE); Jean-Marc Sol, Thionville (FR)

Correspondence Address: NIXON & VANDERHYE, PC, 901 NORTH GLEBE ROAD, 11TH FLOOR, ARLINGTON, VA, 22203, US

(73) Assignee: Centre Luxembourgeois de Recherches pour le Verre et la Ceramique S.A. (C.R.V.C.), Dudelange, Grand Duche de Luxembourg (BE)

(21) Appl. No.: 11/387,045

(22) Filed: Mar. 23, 2006

(51) Int. Cl. G02B 5/08

(52) U.S. Cl. 359/883; 359/826

(57) ABSTRACT

A reflector (e.g., mirror) for use in a solar collector or the like is provided. In certain example embodiments of this invention, a reflector is made performing at least the following steps: (a) forming a reflective coating on a flat glass substrate, (b) cold-bending the glass substrate with the reflective coating thereon; and (c) applying a plate member (e.g., thermoplastic or glass based) to the cold-bent glass substrate, the plate member for maintaining the coated glass substrate in a desired bent orientation. In certain example embodiments, the glass substrate supporting the reflective coating may be maintained in desired bent form by using another glass substrate and a glue layer provided between the another glass substrate and the glass substrate supporting the coating. The bent reflector (e.g., mirror) may be used in a solar collector, or in any other suitable application.

This application is related to a reflector (e.g., mirror) for use in a solar collector or the like. In certain example embodiments of this invention, a reflector for a solar collector or the like is made by (a) forming a reflective coating on a flat glass substrate, (b) cold-bending the glass substrate with the reflective coating thereon using a mold member; and (c) applying a plate member (e.g., thermoplastic or glass based) to the cold-bent glass substrate, the plate member for maintaining the coated glass substrate in a bent orientation. In certain example embodiments of this invention, the reflector may be used in a solar collector, or in any other suitable application.

### BACKGROUND AND SUMMARY OF EXAMPLE EMBODIMENTS OF THE INVENTION

Solar collectors are known in the art. Example solar collectors are disclosed in U.S. Pat. Nos. 5,347,402, 4,056,313, 4,117,682, 4,608,964, 4,059,094, 4,161,942, 5,275,149, 5,195,503 and 4,237,864, the disclosures of which are hereby incorporated herein by reference. Solar collectors include at least one mirror (e.g., parabolic or other type of mirror) that reflects incident light (e.g., sunlight) to a focal location such as a focal point. In certain example instances, a solar collector includes one or more mirrors that reflect incident sunlight and focus the light at a common location. For instance, a liquid to be heated may be positioned at the focal point of the mirror(s) so that the reflected sunlight heats the liquid (e.g., water, oil, or any other suitable liquid) and energy can be collected from the heat or steam generated by the liquid.

FIG. 1 is a schematic diagram of a conventional solar collector, or a part thereof, where a parabolic mirror 1 reflects incident light (or radiation) from the sun 3 and focuses the reflected light on a black body 5 that absorbs the energy of the sun's rays and is adapted to transfer that energy to other apparatus (not shown). By way of example only, the black body 5 may be a conduit through which a liquid or air flows where the liquid or air absorbs the heat for transfer to another apparatus. As another example, the black body 5 may be liquid itself to be heated, or may include one or more solar cells in certain example instances.

FIG. 2 is a cross sectional view of a typical mirror used in conventional solar collector systems. The mirror of FIG. 2 includes a reflective coating 7 supported by a bent glass substrate 9, where the glass substrate 9 is on the light incident side of the reflective coating 7 (i.e., the incident light from the sun must pass through the glass before reaching the reflective coating). This type of mirror is a second or back surface mirror. Incoming light passes through the glass substrate 9 before being reflected by the coating 7; the glass substrate 9 is typically from about 4-5 mm thick. Thus, reflected light passes through the glass substrate twice in back surface mirrors; once before being reflected and again after being reflected on its way to a viewer. Second or back surface mirrors, as shown in FIG. 2, are used so that the glass 9 can protect the reflective coating 7 from the elements in the external or ambient atmosphere in which the mirror is located (e.g., from rain, scratching, acid rain, wind-blown particles, and so forth).

Conventional reflectors such as that shown in FIG. 2 are typically made as follows. The glass substrate 9 is from about 4-5 mm thick, and is heat-bent using temperatures of at least about 580 degrees C. The glass substrate 9 is typically heat/hot bent on a parabolic mold using such high temperatures, and the extremely high temperatures cause the glass to sag into shape on the parabolic mold. After the hot bent glass is permitted to cool to about room temperature, a reflective coating (e.g., silver based coating) is formed on the bent glass substrate. Ceramic pads may then be glued to the panel which may be bolted to a holding structure of the solar collector.

Unfortunately, the aforesaid process of manufacturing reflectors is problematic for at least the following reasons. First, the hot bending (using temperatures of at least 580 degrees C.) may cause distortions in the glass itself, which can lead to optical deficiencies. Second, application of a reflective coating onto a pre-bent glass substrate is difficult at best, and often leads to reduced reflective/mirror quality.

Thus, it will be appreciated that there exists a need in the art for a more efficient technique for making bent reflective coated articles. An example of such an article is a mirror which may be used in solar collector applications or the like.

In certain example embodiments of this invention, a reflector for a solar collector or the like is made by (a) forming a reflective coating on a flat glass substrate, (b) cold-bending the glass substrate with the reflective coating thereon using a mold member; and (c) applying a plate member to the cold-bent glass substrate, the plate member for maintaining the coated glass substrate in a bent orientation. The coating may be a single layer coating, or a multi-layer coating, in different example embodiments of this invention. In certain example embodiments of this invention, the glass substrate with the coating thereon may be bent at a temperature of no more than about 200 degrees C., more preferably no more than about 150 degrees C., more preferably no more than about 100 degrees C., even more preferably no more than about 75 degrees C., still more preferably no more than about 50 degrees C., still more preferably no more than about 40 or 30 degrees C., and most preferably at about room temperature.

In certain example embodiments, the plate member may be flat and may be applied to the flat glass substrate prior to bending thereof. Then, the plate member (e.g., of a thermoplastic or the like) and the glass substrate can be bent together with the thermoplastic optionally being pre-heated to permit more efficient bending thereof.

In certain example embodiments of this invention, there is provided a method of making a mirror, the method comprising: providing a flat glass substrate; forming a reflective coating on the flat glass substrate; after the reflective coating has been formed on the flat glass substrate, bending the glass substrate together with the coating thereon into a desired bent shape, the bending being performed when the glass substrate is at a temperature of no more than about 200 degrees C.; and maintaining the glass substrate and the coating thereon in substantially the desired bent shape by using a thermoplastic member that is attached to the glass substrate and/or the coating thereon.

In other example embodiments of this invention, there is provided a method of making a reflector, the method comprising: providing a flat glass substrate; forming a reflective coating on the flat glass substrate, the reflective coating for reflecting visible and/or IR radiation and comprising at least one reflective layer comprising one or more of Ag, Al and/or Cr; after the reflective coating has been formed on the flat glass substrate, bending the glass substrate together with the coating thereon into a desired bent shape, the bending being performed when the glass substrate is at a temperature of no more than about 200 degrees C.; and maintaining the glass substrate and the coating thereon in substantially the desired bent shape by using a frame member.

In still further example embodiments of this invention, there is provided a mirror comprising: a bent glass substrate; a mirror coating on the bent glass substrate, the mirror coating for reflecting visible light and comprising at least one reflective layer comprising one or more of Ag, Al and/or Cr; wherein the bent glass substrate with the mirror coating thereon is maintained in a desired bent shape by a frame member comprising a thermoplastic, so that if the frame member were removed then the glass substrate would no longer be in the desired bent shape.

In other example embodiments of this invention, there is provided a method of making a coated article, the method comprising: providing a flat glass substrate; forming a reflective coating on the flat glass substrate; after the reflective coating has been formed on the flat glass substrate, bending the glass substrate together with the coating thereon into a desired bent shape, the bending being performed when the glass substrate is at a temperature of no more than about 200 degrees C.; and maintaining the glass substrate and the reflective coating thereon in substantially the desired bent shape by using another glass substrate and a glue layer, wherein the glue layer is provided between the glass substrate that supports the reflective coating and the another glass substrate. A corresponding product may also be provided in this regard wherein the glass substrate and the reflective coating thereon are maintained in substantially the desired bent shape by using another glass substrate and the glue layer so that if the glue layer were not present the glass substrate would not be maintained in its desired bent form.

### BRIEF DESCRIPTION OF THE DRAWINGS

FIG. 1 is a schematic diagram of a conventional solar collector system.

FIG. 2 is a cross sectional view of the second surface mirror used in the conventional solar collector system of FIG. 1.

FIG. 3 illustrates a first step performed in making a bent reflecting according to an example embodiment of this invention.

FIG. 4 illustrates another step performed in making a bent reflecting according to an example embodiment of this invention.

FIG. 5 illustrates another step performed in making a bent reflecting according to an example embodiment of this invention.

FIG. 6 illustrates another step performed in making a bent reflecting according to an example embodiment of this invention.

FIG. 7 illustrates yet another step performed in making a bent reflecting according to an example embodiment of this invention.

FIG. 8 illustrates another optional step performed in making a bent reflecting according to an example embodiment of this invention.

FIG. 9 is a cross sectional view of a reflector according to an embodiment of this invention, where a second surface mirror may be used such that the reflective coating is provided on the side of the glass substrate opposite the light incident side.

FIG. 10 is a cross sectional view of a reflector according to an embodiment of this invention, where a first surface mirror may be used such that the reflective coating is provided on the light incident side of the glass substrate.

FIG. 11 is a flowchart illustrating steps performed in making a mirror according to another example embodiment of this invention.

FIG. 12 is a cross sectional view of the mirror made in the FIG. 11-12 embodiment.

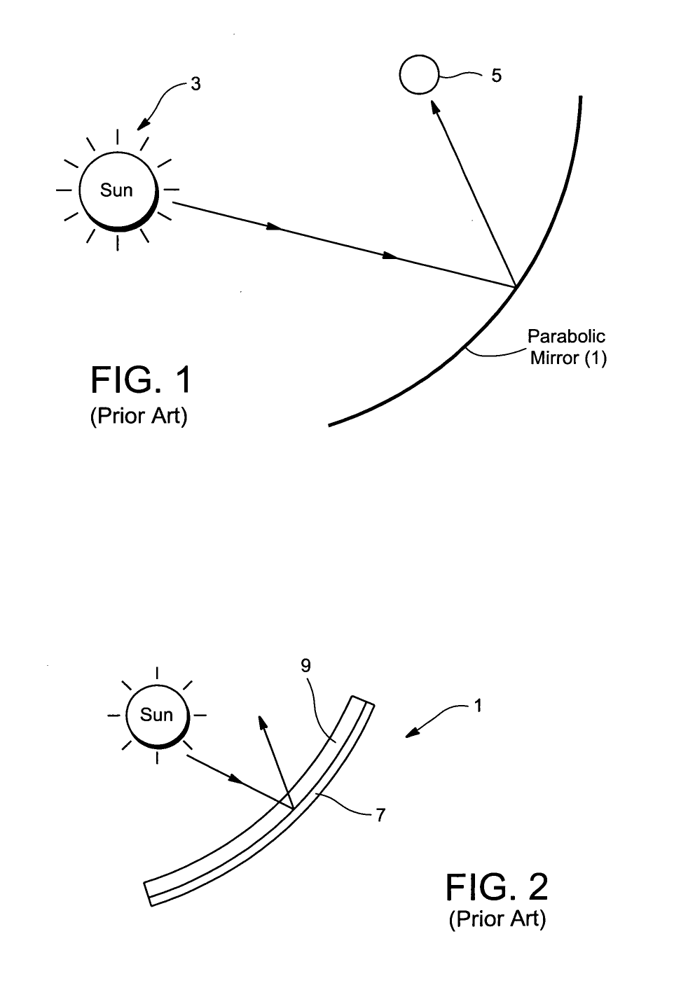

### DETAILED DESCRIPTION OF EXAMPLE EMBODIMENTS OF THE INVENTION

Referring now more particularly to the accompanying drawings in which like reference numerals indicate like parts throughout the several views.

In certain example embodiments of this invention, a reflector for a solar collector or the like is made by (a) forming a reflective coating on a flat glass substrate, (b) cold-bending the glass substrate with the reflective coating thereon using a mold member; and (c) applying a plate member to the cold-bent glass substrate, the plate member for maintaining the coated glass substrate in a bent orientation. In certain example embodiments of this invention, the glass substrate with the coating thereon may be bent at a temperature of no more than about 200 degrees C., more preferably no more than about 150 degrees C., more preferably no more than about 100 degrees C., even more preferably no more than about 75 degrees C., still more preferably no more than about 50 degrees C., still more preferably no more than about 40 or 30 degrees C., and possibly at about room temperature in certain example instances.

In certain example embodiments, the plate member may be flat and may be applied to the flat glass substrate prior to bending thereof. Then, the plate member (e.g., of a thermoplastic or the like) and the glass substrate can be bent together with the thermoplastic optionally being pre-heated to permit more efficient bending thereof.

In certain example embodiments of this invention, the reflector may be used as a mirror in a solar collector, or in any other suitable application. In mirror applications, the mirror may be either a first/front surface mirror or a second surface mirror. However, a second surface mirror is preferred in certain example embodiments, because the glass of the mirror can protect the reflective coating supported thereby from the atmosphere and the like. In a first or front surface mirror, the reflective coating is provided on the front surface of the glass substrate so that incoming light is reflected by the coating before it passes through the glass substrate. Since the light to be reflected does not have to pass through the glass substrate in first surface mirrors (in contrast to rear or second surface mirrors), first surface mirrors generally have higher reflectance than rear surface mirrors and less energy is absorbed by the glass. Thus, the first surface mirrors are more energy efficient than are rear or second surface mirrors. Certain example first surface mirror reflective coatings include a dielectric layer(s) provided on the glass substrate over a reflective layer (e.g., of Al, Ag or the like). However, both first and second surface mirrors may be made and used in different example embodiments of this invention.

In certain example embodiments of this invention, the reflector is a mirror (first or second surface mirrors) which may be used in applications such as one or more of: parabolic-trough power plants, compound parabolic concentrating collectors, solar dish-engine systems, solar thermal power plants, and/or solar collectors, which rely on mirror(s) to reflect and direct solar radiation from the sun. In certain example instances, the mirror(s) may be mounted on a steel or other metal based support system. In certain example embodiments, the reflector may be an IR reflecting coated article that may be used in window or other applications. In such IR reflecting embodiments, the reflective coating may include at least one infrared (IR) reflecting layer of or including a material such as silver, gold, or the like, and may be at least partially transmissive to visible light while blocking significant amounts of IR radiation, and may be used in window or other suitable applications.

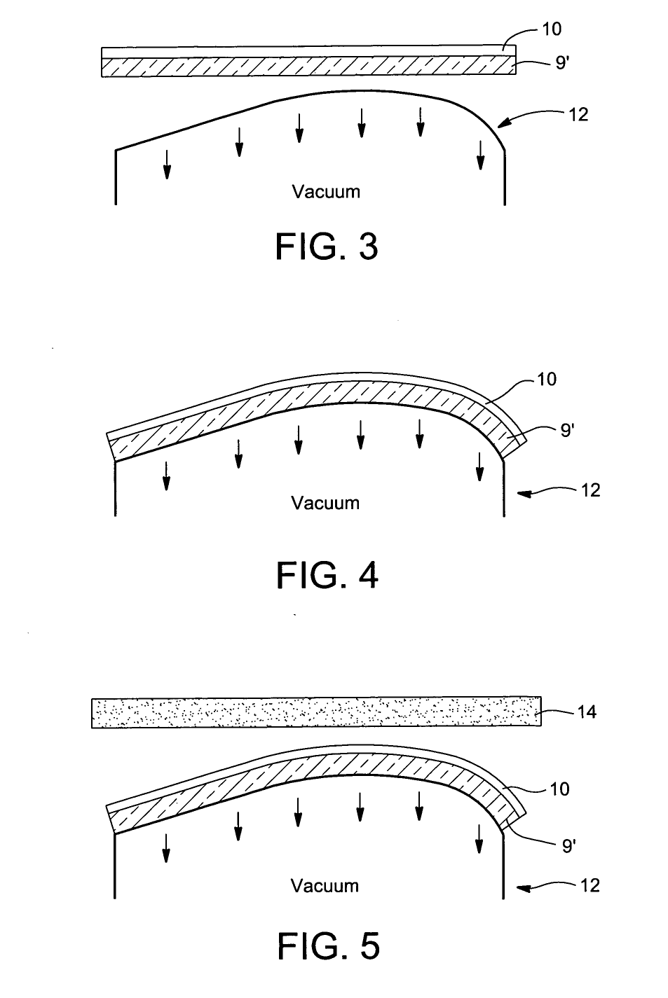

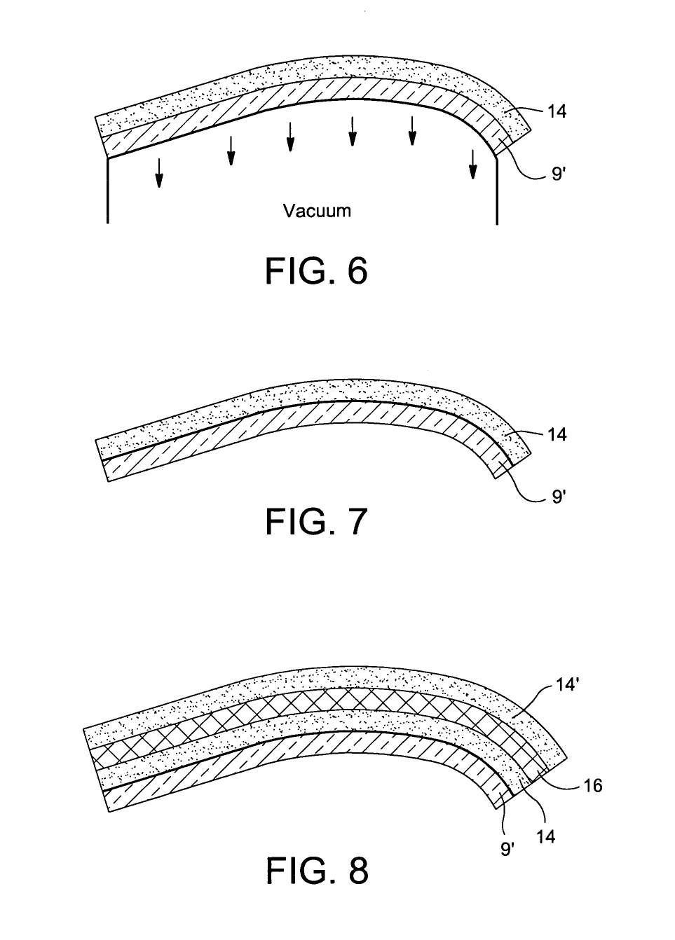

FIGS. 3-8 illustrate an example process of making a reflector according to an example embodiment of this invention. First, a flat glass substrate (e.g., soda-lime-silica based float glass) 9′ is provided in uncoated form. The flat glass substrate 9′ may be clear or green colored, and may be from about 0.5 to 2.5 mm thick, more preferably from about 1.0 to 2.25 mm thick, and most preferably from about 1.0 to 2.0 mm thick. Then, a reflective coating 10 is formed on the flat glass substrate 9′ via sputtering, sol-gel, or the like. The reflective coating 10 is shown in FIGS. 3-5 and 9-10, but is not shown in FIGS. 6-8 for purposes of simplicity. The reflective coating 10 may be made up of a single reflective layer, or alternatively may be made up of a plurality of layers.

In single layer embodiments, the reflective coating 10 may be made up of a single reflective layer of aluminum, silver, chromium, gold or the like that is sufficient to reflect the desired radiation (e.g., visible and/or IR radiation). In multi-layer embodiments, the reflective coating 10 may include a reflective layer of aluminum, silver, chromium, gold or the like and other layer(s) such as silicon oxide, silicon nitride which may be provided over and/or under the reflective layer. Other example reflective coatings 10 are set forth in U.S. Patent Document Nos. 2003/0179454, 2005/0083576, Ser. Nos. 10/945,430, 10/959,321, U.S. Pat. No. 6,783,253 or 6,934,085, any of which may be used herein, the disclosures of which are hereby incorporated herein by reference.

In certain example mirror embodiments, the reflective layer (e.g., Al, Ag, Au or Cr based layer) of the coating 10 may have an index of refraction value “n” of from about 0.05 to 1.5, more preferably from about 0.05 to 1.0. When the reflective layer of the coating 10 is of or based on Al, the index of refraction “n” of the layer may be about 0.8, but it also may be as low as about 0.1 when the layer is of or based on Ag. In certain example embodiments of this invention, a reflective metallic layer of Al may be sputtered onto the glass substrate 9′, directly or indirectly, using a C-MAG rotatable cathode Al inclusive target (may or may not be doped) and/or a substantially pure Al target (>=99.5% Al) (e.g., using 2 C-MAG targets, Ar gas flow, 6 kW per C-MAG power, and pressure of 3 mTorr), although other methods of deposition for the layer may be used in different instances. In sputtering embodiments, the target(s) used for sputtering Al reflective layer may include other materials in certain instances (e.g., from 0-5% Si to help the Al bond to the glass or some other layer). The reflective layer(s) of the coating 10 in certain embodiments of this invention has a reflectance of at least 75% in the 500 nm region as measured on a Perkin Elmer Lambda 900 or equivalent spectrophotometer, more preferably at least 80%, and even more preferably at least 85%, and in some instances at least about 90% or even 95%. Moreover, in certain embodiments of this invention, the reflective layer is not completely opaque, as it may have a small transmission in the visible and/or IR wavelength region of from 0.1 to 5%, more preferably from about 0.5 to 1.5%. The reflective layer may be from about 20-150 nm thick in certain embodiments of this invention, more preferably from about 40-90 nm thick, even more preferably from about 50-80 nm thick, with an example thickness being about 65 nm when Al is used for the reflective layer.

It is advantageous that the reflective coating 10 is formed (e.g., via sputtering or the like) on the glass 9′ when the glass is in a flat form, as shown in FIG. 3. This permits the coating to be formed in a more consistent and uniform manner, thereby improving the reflective characteristics thereof so that the final product may achieve improved optical performance (e.g., better and/or more consistent reflection of visible and/or IR radiation).

Once the reflective coating 10 has been formed on the flat glass substrate 9′ to form a coated article as shown in FIG. 3, the flat coated article is positioned over a mold 12. The mold 12 may be in the shape of a parabolic or the like, to which it is desired to bend the coated article. Moreover, as shown in FIG. 3, the mold 12 may have a plurality of holes defined therein for drawing a vacuum to help bend the coated article. The coated article including the glass ′9 and reflective coating 10 is positioned over and lowered onto the surface of the mold 12. The coated article, including the glass 9′ and coating 10 thereon, is then cold-bent along the parabolic surface of the mold 12 as shown in FIG. 4. The cold-bending may be achieved via a gravity sag on the parabolic surface of the mold 12, with the optional help of the vacuum system which helps draw the coated article toward the parabolic mold surface 12. In certain example embodiments, the glass 9′ may directly contact the parabolic bend surface of the mold 12 during the bending process.

The bending of the coated glass article shown in FIGS. 3-4 is a cold-bend technique, because the glass is not heated to its typical bending temperature(s) of at least about 580 degrees C. Instead, during the bending of FIGS. 3-4, the glass substrate 9′ with the coating 10 thereon may be bent while at a temperature of no more than about 200 degrees C., more preferably no more than about 150 degrees C., more preferably no more than about 100 degrees C., even more preferably no more than about 75 degrees C., still more preferably no more than about 50 degrees C., still more preferably no more than about 40 or 30 degrees C., and possibly at about room temperature in certain example instances. In order to not exceed the maximum tensile stress (e.g., 20.7 to 24.15 MPa) that would lead to spontaneous breakage of the glass during cold bending in this configuration, the thickness of glass substrate 9′ is kept relatively thin. For example, in certain example embodiments of this invention, the glass 9′ is from about 0.5 to 2.5 mm thick, more preferably from about 1.0 to 2.25 mm thick, and most preferably from about 1.0 to 2.0 mm thick.

After the coated article including the glass 9′ and coating 10 has been cold-bent to its desired shape (e.g., parabolic shape) as shown in FIG. 4, this bent shape is maintained using a plate/frame such as flat thermoplastic plate 14 on which the coated article may be glued or otherwise adhered (see FIG. 5). Optionally, addition of an adequate adhesive agent (not shown) may be used to caused excellent adhesion between the coated article and the thermoplastic plate 14. The thermoplastic plate 14 may be transparent or opaque in different embodiments of this invention. Thermoplastic plate 14 may be pre-heated, before it is applied to the coated article, to a temperature of from about 70 to 250 degrees C., more preferably from about 80-200 degrees C., and most preferably from about 100-200 degrees C. The pre-heating of the thermoplastic plate 14 permits the plate 14 to be bent in the manner shown in FIGS. 5-6 as it is positioned over the coated article on the mold 12. Optionally, fixation elements (e.g., fasteners such as clamps, screws or the like, not shown) may be provided at this point to fasten the bent plate 14 to the bent coated article including glass 9′ and coating 10. After the thermoplastic plate 14 has been bent over the coated article and adhered thereto, as shown in FIG. 6, the plate 14 is allowed to cool (e.g., to room temperature) in order to freeze its bent shape around the exterior of the coated article. The bent article may then be removed from the mold as shown in FIG. 7. The shaped thermoplastic plate 14 then maintains the bent shape of the glass 9′ to which it is adhered and/or fastened, thereby keeping the glass 9′ and coating 10 thereon in a desired bent shape/form, as shown in FIG. 7.

Note that it is possible to use stiffening material (e.g., glass fibers or the like) in the plate 14 so provide the plate 14 with substantially the same dilatation properties as the glass 9′ (e.g., embedded glass fibers in polypropylene). Optionally, the thermoplastic plate 14 may also cover the edges of the glass 9′ and coating 10 so as to function as a mechanical protector to protect the edges of the glass and possibly prevent or reduce oxidation or degradation of the glass 9′ and/or coating 10.

Optionally, as shown in FIG. 8, the section inertia of the thermoplastic plate 14 may be increased by providing spacers (e.g., honeycomb spacers) 16 and another similarly bent thermoplastic plate 14′ on the bent glass substrate 9′ over the plate 14. The combination of layers 14, 16 and 14′ may be applied together at the same time as one unit on the glass 9′, or alternatively may be applied sequentially as separate layers in different example embodiments of this invention.

While FIGS. 3-5 illustrate that the glass 9′ is bent prior to the thermoplastic plate 14 being attached thereto via adhesive and/or fasteners, this invention is not so limited. For example, in other example embodiments of this invention, the thermoplastic plate 14 may be flat and may be applied to the flat glass substrate 9′ and/or coating 10 prior to the bending thereof (e.g., the plate 14 may be adhered or otherwise attached to the glass 9′ and/or coating 10 in FIG. 3 prior to bending of the glass). Then, the plate member 14 and the glass substrate 9′ can be bent together with at least the thermoplastic plate 14 optionally being pre-heated to permit more efficient bending thereof.

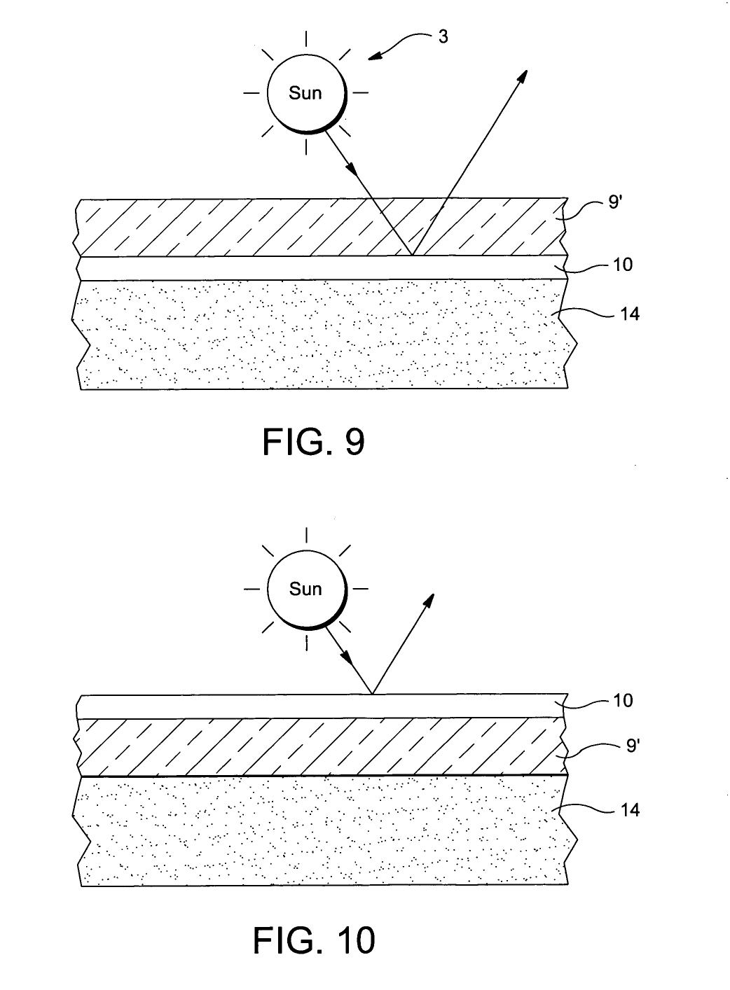

FIGS. 9-10 are cross sectional views of portions of bent mirrors according to different example embodiments of this invention, and illustrate that first surface mirrors or back surface mirrors may be used in different instances. FIG. 9 illustrates that the mirror is a back or second surface mirror because the incident light from the sun has to first pass through the glass 9′ before being reflected by coating 10. In contrast, FIG. 10 illustrates that the mirror is a front or first surface mirror because the incident light is reflected by the coating 10 before reaching the glass 9′. Either type of mirror may be used in different example embodiments of this invention.

Certain example embodiments of this invention are advantageous for a number of reasons. For example and without limitation, the thin glass 9′ used in the bending process is advantageous in that it permits high reflection characteristics to be realized, low weight characteristics and reduces constraints on the reflective coating. The cold-bending is advantageous in that it reduces distortions of the glass 9′ and/or coating 10 and provides for good shape accuracy, and the application of the coating 10 to the glass 9′ when the glass is in a flat form allows for improved mirror and/or reflective qualities to be realized. Moreover, the laminate nature of the product, with the thermoplastic plate 14 being adhered to the glass 9′, provides for better safety and allows the reflector to perform even if it should be cracked or broken.

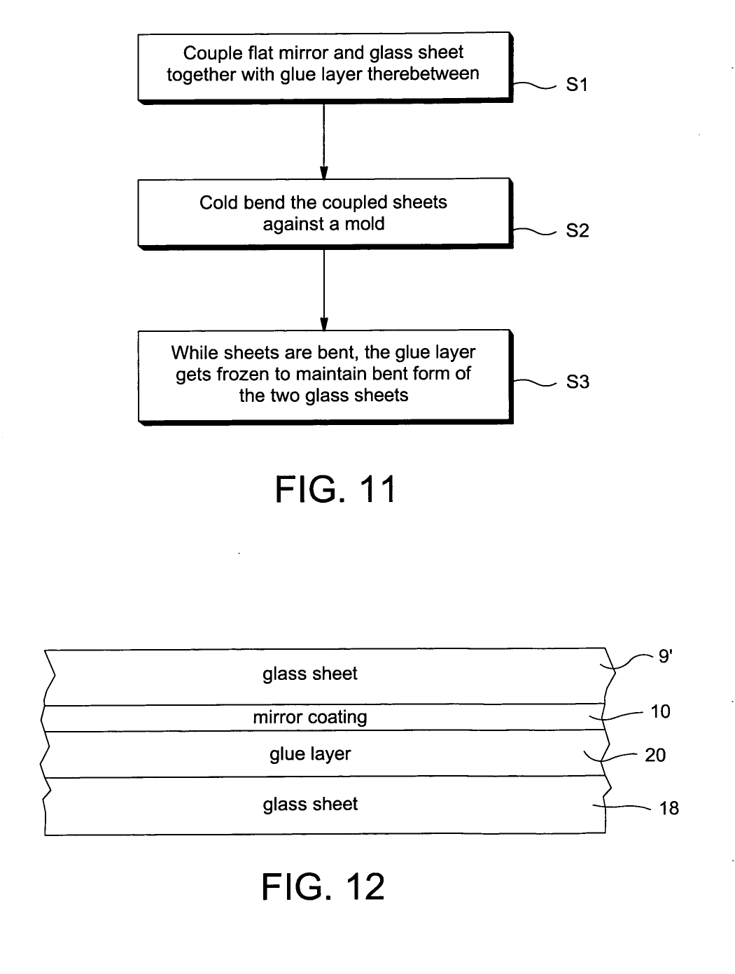

In certain example embodiments discussed above, the thermoplastic member (thermoplastic plate 14) maintains the shape of the cold-bent coated article (e.g., mirror). However, in another example embodiment of this invention, the thermoplastic member may be replaced with a glue layer and another glass sheet. Such an example another embodiment is shown with reference to FIGS. 11-12.

Referring to FIGS. 11-12, a flat glass substrate (e.g., soda-lime-silica based float glass) 9′ is provided in uncoated form. The flat glass substrate 9′ may be clear or green colored, and may be from about 0.5 to 2.5 mm thick, more preferably from about 1.0 to 2.25 mm thick, and most preferably from about 1.0 to 2.0 mm thick. Then, a reflective coating 10 (e.g., any mirror coating discussed herein, or any other suitable mirror coating) is formed on the flat glass substrate 9′ via sputtering, sol-gel, wet chemical application, or the like. As discussed above, the reflective coating 10 may be made up of a single reflective layer, or alternatively may be made up of a plurality of layers. For example, in single layer embodiments, the reflective coating 10 may be made up of a single reflective layer of aluminum, silver, chromium, gold or the like that is sufficient to reflect the desired radiation (e.g., visible and/or IR radiation). In multi-layer embodiments, the reflective coating 10 may include a reflective layer of aluminum, silver, chromium, gold or the like and other layer(s) such as silicon oxide, silicon nitride which may be provided over and/or under the reflective layer. Other example reflective coatings 10 are set forth in U.S. Patent Document Nos. 2003/0179454, 2005/0083576, Ser. Nos. 10/945,430, 10/959,321, U.S. Pat. No. 6,783,253 or 6,934,085, any of which may be used herein, the disclosures of which are hereby incorporated herein by reference. It is advantageous that the reflective coating 10 is formed (e.g., via sputtering, wet chemical application, sol-gel, or the like) on the glass 9′ when the glass is in a flat form; as this permits the coating to be formed in a more consistent and uniform manner thereby improving the reflective characteristics thereof so that the final product may achieve improved optical performance (e.g., better and/or more consistent reflection of visible and/or IR radiation).

Then, the coated article including flat glass substrate 9′ with reflective coating 10 thereon is coupled to another flat glass substrate 18 with a glue layer 20 provided therebetween (see step S1 in FIG. 11). The glue layer 20 may be made up of a polymer based material in certain example instances. In certain example embodiments, the glue layer 20 may be made of or include polyvinyl butyral (PVB) or any other suitable polymer based glue material. The glue layer may be initially provided between the glass substrates 9′ and 18 is solid and/or non-adhesive form. Then, the multi-layer structure shown in FIG. 12 including glass substrates 9′ and 18, with reflective coating 10 and glue layer 20 therebetween, is cold bent on a mold 12 as described above (e.g., see S2 in FIG. 11, and FIGS. 3-4). The curved mold 12 may be made of steel or any other suitable material. Because the glue layer may not be in final adhesive form at this point, the glass substrates 9′ and 18 together with the coating 10, glue layer 20 and mold can be maintained in the bent sandwich form by mechanical clamps around the edges of the sandwich, or by any other suitable means. While the multi-layer structure is in its desired cold-bent form on the mold (e.g., with the clamps holding the sandwich in cold-bent form on the mold 10), the glue layer (e.g., PVB) 20 is frozen in an adhesive position in order to maintain the glass substrates 9′ and 18 of the laminate in their desired bent form (see S3 in FIG. 11). The mold may then be removed. In order to “freeze” the glue layer 10, for example and without limitation, the glass substrates 9′ and 18 together with the coating 10, glue layer 20 and mold (e.g., possibly with the clamps) in the bent sandwich form can be positioned in a heating oven (e.g., autoclave) (not shown) and heating caused in the oven can cause the glue layer (e.g., PVB) 20 to turn into an adhesive which adheres the two substrates 9′ and 18 to each other (i.e., “freeze” the glue layer). After heating and curing of the glue layer 20, the mold may be removed. The now final adhesive glue layer 20, as heated and cured, can function to maintain the glass substrates/sheets 9′ and 18 in their desired bent form along with coating 10.

It is noted that in the FIG. 11-12 embodiment, the reflective coating 10 may be on either major surface of the glass substrate 9′. Thus, the coating 10 may or may not directly contact the glue layer 20.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of making a mirror, the method comprising:
providing a flat glass substrate;
forming a reflective coating on the flat glass substrate;
after the reflective coating has been formed on the flat glass substrate, bending the glass substrate together with the coating thereon into a desired bent shape, the bending being performed when the glass substrate is at a temperature of no more than about 200 degrees C.;
maintaining the glass substrate and the coating thereon in substantially the desired bent shape by using a thermoplastic member that is attached to the glass substrate and/or the coating thereon; and
pre-heating the thermoplastic member to a temperature of from about 80-200 degrees C. prior to a bending of the thermoplastic member, wherein the thermoplastic member is bent along with the glass substrate supporting the reflective coating.

2. The method of claim 1, wherein said bending of the glass substrate is performed when the glass substrate is at a temperature of no more than about 150 degrees C.

3. The method of claim 1, wherein said bending of the glass substrate is performed when the glass substrate is at a temperature of no more than about 100 degrees C.

4. The method of claim 1, wherein said bending of the glass substrate is performed when the glass substrate is at a temperature of no more than about 50 degrees C.

5. The method of claim 1, wherein said bending of the glass substrate is performed when the glass substrate is at approximately room temperature.

6. The method of claim 1, wherein the thermoplastic member is attached to the glass substrate via one or both of: (a) an adhesive provided between the coating and the thermoplastic member, and/or (b) a plurality of fasteners.

7. The method of claim 1, wherein the thermoplastic member is attached to the glass substrate and/or coating, after the glass substrate has been bent; and wherein the glass substrate is from about 1.0 to 2.25 mm thick.

8. The method of claim 1, wherein the thermoplastic member is attached to the glass substrate and/or coating, before the glass substrate has been bent.

9. (canceled)

10. The method of claim 1, wherein the coating comprises at least one reflective layer comprising Al, Ag and/or Cr.

11. The method of claim 1, wherein the bent shape comprises a substantially parabolic shape, and wherein the mirror is used as a mirror in a solar collector.

12. A method of making a reflector, the method comprising:
providing a flat glass substrate;
forming a reflective coating on the flat glass substrate, the reflective coating for reflecting visible and/or IR radiation and comprising at least one reflective layer comprising one or more of Ag, Al and/or Cr;
after the reflective coating has been formed on the flat glass substrate, bending the glass substrate together with the coating thereon into a desired bent shape, the bending being performed when the glass substrate is at a temperature of no more than about 200 degrees C.; and
maintaining the glass substrate and the coating thereon in substantially the desired bent shape by using a frame member; and
pre-heating the frame member to a temperature of from about 80-200 degrees C. prior to a bending of the frame member, wherein the frame member is bent either along with the glass substrate or prior to being coupled with the glass substrate.

13. The method of claim 12, wherein said bending of the glass substrate is performed when the glass substrate is at a temperature of no more than about 150 degrees C.

14. The method of claim 12, wherein said bending of the glass substrate is performed when the glass substrate is at a temperature of no more than about 100 degrees C.

15. The method of claim 12, wherein said bending of the glass substrate is performed when the glass substrate is at a temperature of no more than about 50 degrees C.

16. The method of claim 12, wherein said bending of the glass substrate is performed when the glass substrate is at approximately room temperature.

17. The method of claim 12, wherein the frame member comprises one of: (1) a thermoplastic member that is attached to the glass substrate via one or both of: (a) an adhesive provided between the coating and the thermoplastic member, and/or (b) a plurality of fasteners, or (2) another glass substrate with a glue layer being provided between the another glass substrate and the glass substrate supporting the reflective coating.

18. (canceled)

19. The method of claim 12, wherein the reflector is used as a vehicle window or as a mirror in a solar collector.

20. The method of claim 12, wherein the glass substrate is from 1.0 to 2.25 mm thick

21-27. (canceled)

28. A method of making a mirror, the method comprising:
providing a flat glass substrate;
forming a reflective coating on the flat glass substrate;
after the reflective coating has been formed on the flat glass substrate, bending the glass substrate together with the coating thereon into a desired bent shape, the bending being performed when the glass substrate is at a temperature of no more than about 200 degrees C.;
maintaining the glass substrate and the coating thereon in substantially the desired bent shape by using a thermoplastic member that is attached to the glass substrate and/or the coating thereon; and
wherein the thermoplastic member is attached to the glass substrate and/or coating, before the glass substrate has been bent.

29. The method of claim 28, wherein the thermoplastic member is attached to the glass substrate via one or both of: (a) an adhesive provided between the coating and the thermoplastic member, and/or (b) a plurality of fasteners.

30. The method of claim 28, wherein the bent shape comprises a substantially parabolic shape, and wherein the mirror is used as a mirror in a solar collector.

31. The method of claim 28, wherein said bending of the glass substrate is performed when the glass substrate is at a temperature of no more than about 100 degrees C.

32. The method of claim 28, wherein said bending of the glass substrate is performed when the glass substrate is at approximately room temperature.
